(19) United States
(12) Patent Application Publication
(10) Pub. No.: US 2018/0149776 A1
(43) Pub. Date: May 31, 2018

(54) OPTICAL CROSS TALK MITIGATION FOR LIGHT EMITTER

(71) Applicant: Microsoft Technology Licensing, LLC, Redmond, WA (US)

(72) Inventors: Ravi Kiran Nalla, San Jose, CA (US); Raymond Kirk Price, Redmond, WA (US)

(21) Appl. No.: 15/362,318

(22) Filed: Nov. 28, 2016

(51) Int. Cl. G02B 5/00; H04N 5/225; G02B 27/01

(52) U.S. Cl. CPC G02B 5/003; H04N 5/2256; G02B 2027/0138; G02B 2027/0178; G02B 27/0172

(57) ABSTRACT

A system and method are disclosed for reducing light from one or more light sources from entering into an optical sensor by reflection off of a visor and/or waveguiding within the visor. In embodiments, a shroud may be provided around the light source to block light from reflecting off of the visor and entering the optical sensor. A pattern of one or more grooves may also be formed in the visor to block light from waveguiding into the visor and entering the optical sensor.

### BACKGROUND

Head mounted display devices used for example in augmented reality environments often have multiple cameras used for mapping and tracking purposes. Some of these cameras are active, in that they include their own illumination source, such as a laser or LED, to actively illuminate the scene. Active cameras include a depth camera for mapping the scene and recognizing gestures. Other cameras are passive, having no illumination source. Passive cameras include head tracking cameras for estimating head pose.

One problem with conventional head mounted display devices is that the high-powered light from active cameras, together with the tight spacing of the cameras behind the visor, may result in optical crosstalk between infrared light emitters and sensors that interferes with both the active and passive camera images. This may occur two ways. First, some portion of the light from an illumination source may be reflected by the visor directly back into optical sensors of the active and/or passive cameras according to Fresnel's equations. Second, light from the illumination source may couple into the visor, traveling through the visor and into optical sensors of the active and/or passive cameras. This phenomena, referred to as waveguiding, may be worsened as a result of smudges, contamination, fingerprints, and scratches on the visor surface.

### SUMMARY

Embodiments of the present technology relate to a system and method for preventing optical cross talk between one or more light sources and one or more optical sensors by reflection off of a visor and/or waveguiding within the visor. In embodiments, the system may be incorporated into a device, such as a head mounted display device, including one or more active and passive cameras mounted behind a visor. The one or more active cameras may include a depth camera including one or more IR light sources and an optical sensor which together operate to sense the depth of objects within the field of view of the depth camera. The one or more passive cameras may include head tracking cameras for estimating head pose, and video cameras for capturing video of a scene.

The system includes a number of light blocking components for preventing optical cross talk between light sources and sensors within a device such as a head mounted display device. The light blocking components may include a shroud mounted around the light source(s) of the one or more active cameras. The shroud may be optically opaque to the wavelengths of light emitted by the one or more light sources. The light blocking components may further include a gasket between the visor and the shroud creating a seal between the shroud and the visor.

The light blocking components may further include one or more features formed in or on the visor for disrupting waveguided light in the visor from reaching optical sensors of the cameras. The waveguide obstructing features may for example be one or more grooves formed in the visor. The grooves may be coated or filled with a material that is optically opaque to the wavelengths of light emitted by the one or more light sources. The grooves and opaque material block light from the one or more light sources that may otherwise enter the optical sensor via waveguiding.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of a virtual reality environment including real and virtual objects.

FIG. 2 is a front view of a head mounted display device including light blocking features around the light sources according to embodiments of the present technology.

FIG. 3 is a top cross-sectional view of a light source, shroud and gasket according to a first embodiment of the present technology.

FIG. 4 is a top cross-sectional view of a light source, grooves and opaque material according to a second embodiment of the present technology.

FIGS. 5-9 are top cross-sectional views of a light source and light disrupting features according to further embodiments of the present technology.

FIG. 10 is a front view of a head mounted display device including light blocking features around optical sensors according to embodiments of the present technology.

FIG. 11 is a front view of a head mounted display device including light blocking features around optical sensors according to further embodiments of the present technology.

### DETAILED DESCRIPTION

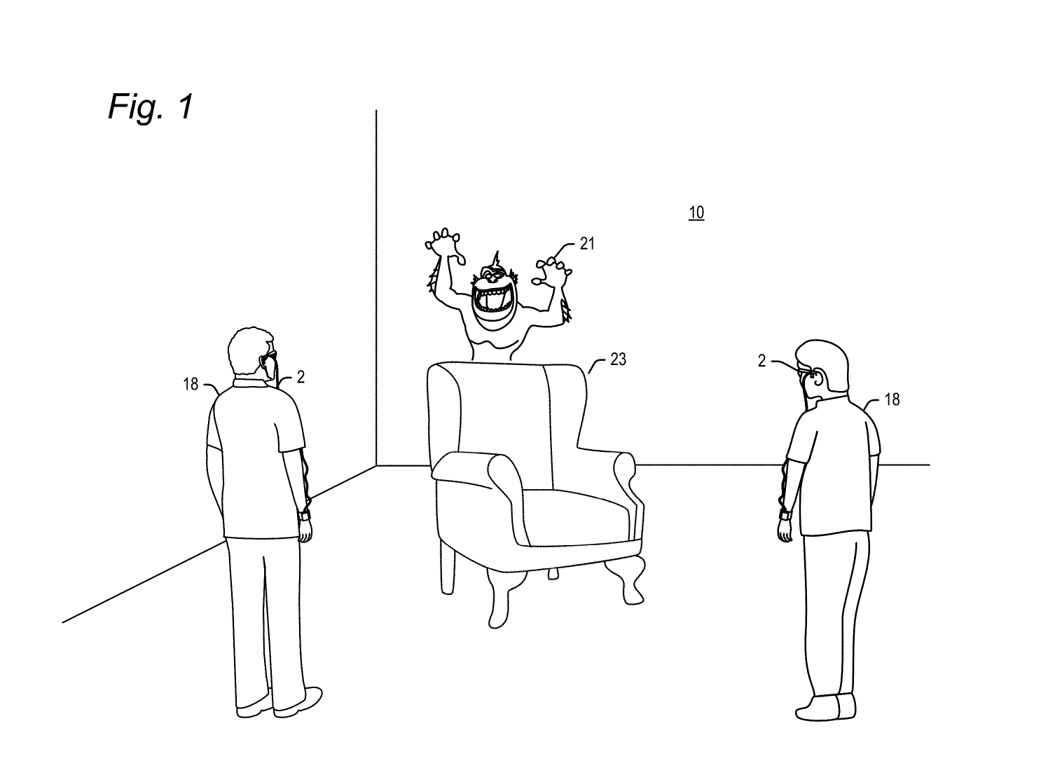

Embodiments of the present technology will now be described with reference to the figures, which in general relate to system of light blocking components for reducing optical cross talk within and between active and passive cameras mounted behind an optical shield such as a visor. In one embodiment explained below, one or more of the light blocking components may be implemented in the light sources and/or sensors of a head mounted display device (HMD) for presenting an augmented reality experience. FIG. 1 illustrates an augmented reality environment 10 for providing an augmented reality experience to users by fusing virtual content 21 with real content 23 within each user's field of view. FIG. 1 shows users 18 wearing an HMD device 2 for presenting the augmented reality experience to the users. The description below focuses on the light blocking components for preventing optical cross talk between light sources and optical sensors of the active and passive cameras. Additional components of the head mounted display device used to generate an augmented reality experience but not directly related to the optical cross talk mitigation of the present technology are omitted. However, such additional components are described for example in U.S. Patent Publication No. 2013/0326364 entitled “Position Relative Hologram Interactions,” published on Dec. 5, 2013.

It is further understood that one or more of the light blocking components according to the present technology may be used in a wide variety of imaging devices other than those used in an HMD. The present technology may be used in any of various devices including cameras behind a shield, where light from at least one of the cameras interferes with the camera images as a result of the light reflecting off the shield and/or waveguiding within the shield.

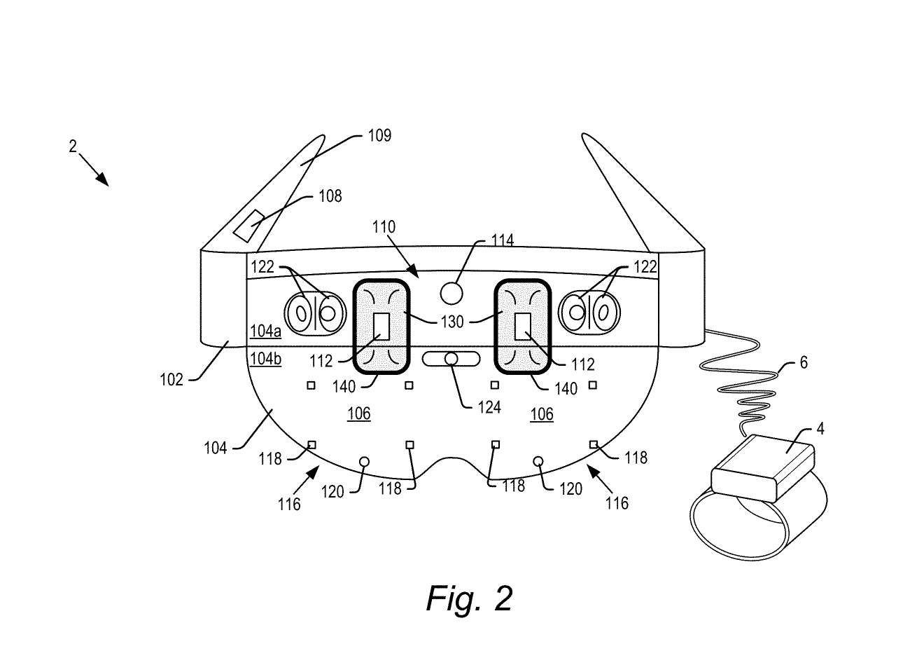

As shown in FIG. 2, an HMD device 2 may include glasses frame 102 supporting a visor 104 to be worn in front of a user's eyes. Details of the visor 104 are provided below. The device 2 may further include optical assemblies 106 including lenses and optical waveguides for presenting real and virtual objects to the eyes of a wearer. Control circuit 108 may be mounted in the frame 102 (either in the temple arms 109 as shown or the visor 104) to provide various electronics that support the components of head mounted display device 2. The head mounted display device 2 may include or be in communication with its own processing unit 4, for example via a flexible wire 6.

The HMD 2 may further include a variety of active and passive cameras mounted behind and adjacent to the visor 104. The active cameras may include for example a depth camera 110 having a pair of light sources 112 and an optical sensor 114 which may be an image sensor. The light sources 112 may be semiconductor devices such as for example laser diodes emitting for example pulsed light in the IR wavelengths. Other types of light sources are contemplated, such as light emitting diodes. The optical sensor 114 may be configured to capture a depth image of an area in the field of view of the sensor 114. The depth image may include a two-dimensional (2-D) pixel array of the captured area where each pixel in the 2-D pixel array may calculate a distance of an object in the captured area from the depth sensor 114. The depth image may capture depth values of the area via any suitable technique including, for example, gated and phase modulated time-of-flight, structured light, stereo image, or the like.

The active cameras may further include a pair of eye tracking cameras 116, one for each eye of a user, for sensing a gaze direction of the user. The eye tracking cameras may include a plurality of IR light sources 118 (four shown for each camera 116) which emit IR light toward the left and/or right eyes. Light reflected off of the left and/or right eyes is received back within optical sensors 120 which may be image sensors. Based on the amount of light received back in the respective sensors, the direction of the user's gaze may be determined. There may be a single eye tracking camera 116, and each eye tracking camera may have fewer or greater numbers of light sources 118, in further embodiments.

The passive cameras shown in FIG. 2 may include one or more head tracking cameras 122. Using methods such as simultaneous location and mapping (SLAM), the cameras are able to register key features within the scene, and determine a change in head position from frame to frame of image data captured by the head tracking cameras, and an estimation of absolute head position. While four head tracking cameras are shown, there may be more or less than that in further embodiments.

The passive cameras shown in FIG. 2 may further include a video camera 124 for capturing visible video or still images of the scene. While one video camera 124 is shown. There may be more than one camera 124 in further embodiments. It is understood that HMD 2 may include other active and/or passive cameras in addition to or instead of those shown in FIG. 2.

As noted, some or all of the depth camera 110, eye tracking camera 116, head tracking cameras 122 and video camera 124 may be adjacent to the visor 104. In embodiments, being adjacent means that the one or more light sources and/or optical sensors of the camera are behind the visor (when worn by a user) and slightly spaced from, or directly affixed to, a surface of the visor 104. Slightly spaced may include being spaced from the visor by up to 2 mm, but slightly spaced may include spacings that are larger than 2 mm in further embodiments.

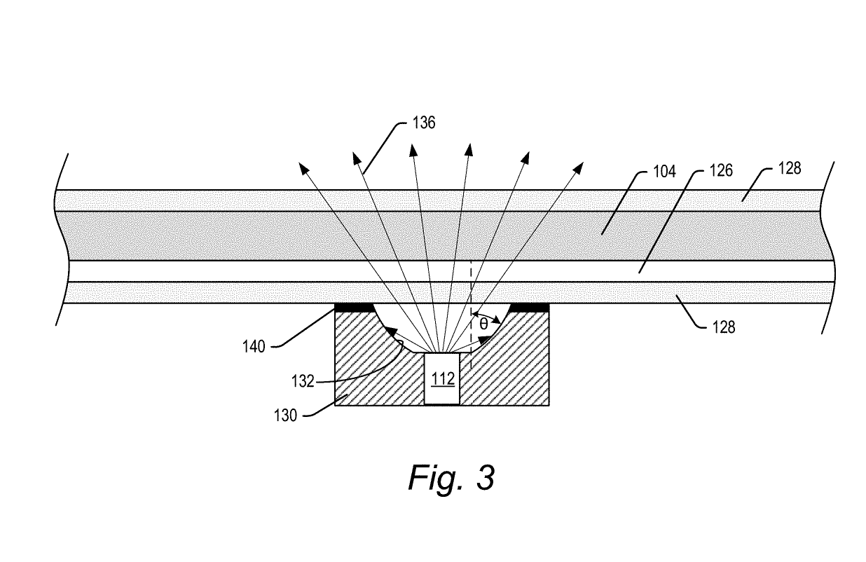

The visor 104 may for example be formed of injection-molded polycarbonate, though it may be formed of other plastics or glass in further embodiments. The visor 104 may have coatings with different indicies of refraction than the air on either side of the visor to make an antireflection coating, and are designed to have very low reflectivity at the wavelength band of interest. Referring to the front view of FIG. 2 and the cross-sectional top view of FIG. 3, an upper portion 104a of the visor 104 may be coated with the dye 126 which is opaque to light in the visible wavelength range but (at least partially) transparent to light in the infrared wavelengths of the light sources 112. The dye 126 may be omitted from a lower portion 104b of the visor 104 (worn in front of a user's eyes) so that a user may receive visible light and view their environment.

The visor 104 may further include an anti-reflective coating 128 applied to one or both surfaces of the visor 104. It is understood that one or more of the coated layers 126, 128 may be omitted in further embodiments, and the visor 104 may have additional or alternative coatings in further embodiments. The light blocking components described below may be used with shields other than a visor 104, such as for example shields that are not head-worn.

In accordance with aspects of the present technology, HMD 2 may include light blocking components for preventing light from the depth sensor light sources 112 from entering any of the adjacent optical sensors 114, 120, 122 and 124 of the active and/or passive components as a result of reflecting off the visor or waveguiding within the visor. Embodiments of the light blocking components are now described with reference to FIGS. 2-11. FIGS. 2 and 3 illustrate a shroud 130 and a gasket 140 forming part of the light blocking components in embodiments of the present technology. The shroud 130 may be formed entirely around both of the light sources 112 of the depth sensor 110, each forming a cone-like structure extending from the light sources 112 toward the visor 104. The shroud 130 may be formed of polycarbonate or other plastic or glass, and have optical filtering properties such that it blocks light at the wavelengths emitted by the one or more light sources 112. It may block other wavelengths of light in further embodiments. Thus, light rays (136) emitted from each light source 112 may pass straight through the visor 104, but light leaving the sources 112 above some predefined angle θ is blocked and absorbed by the shroud 112.

Each shroud 130 may include angled sidewalls 132 adjacent the light sources 112 to define a generally cone-shaped structure having an opening at one end around each light source 112, and an opening at the opposite end adjacent the visor 104. The sidewalls 132 may be curved or straight. In embodiments, the angle θ of the sidewalls may be selected so as to be large enough to encompass at least the field of view of the depth sensor 110. In embodiments, the angle θ is also small enough to prevent light from striking the visor 104 at an angle which would result in total internal reflectance or Fresnel reflection of the incident light, instead of the desired propagation of the light through the visor 104. In embodiments, the angle θ of the sidewalls 132 may be 30° at a point adjacent the light source 112, but the angle θ may be larger or smaller than that in further embodiments.

The shroud 130 may be affixed to the visor 104, for example against one of the antireflective coatings 128. As shown in FIGS. 2 and 3, in order to prevent light from the one or more light sources 112 from reflecting off or into the visor 104 at the interface between the visor 104 and shroud 130, a gasket 140 may be provided at the interface between the visor 104 and shroud 130. The gasket 140 may have an index of refraction that is matched to, or greater than, the index of the visor 104, so that light striking the gasket is absorbed into the gasket 140 instead waveguiding in or reflecting off the visor.

Each gasket 140 may completely encircle the shroud 130 and light source 112, and may be formed of a gasket material of low reflectivity to absorb/block any light that impinges upon it. In the embodiment shown, the shrouds 130 and gaskets 140 have a generally rectangular shape, but the shrouds 130 and gaskets 140 may have other shapes in further embodiments, including for example square, oval and circular. The gaskets 140 may also be provided with an adhesive on opposed surfaces so that the gaskets 140 affix the shrouds 130 to the visor 104.

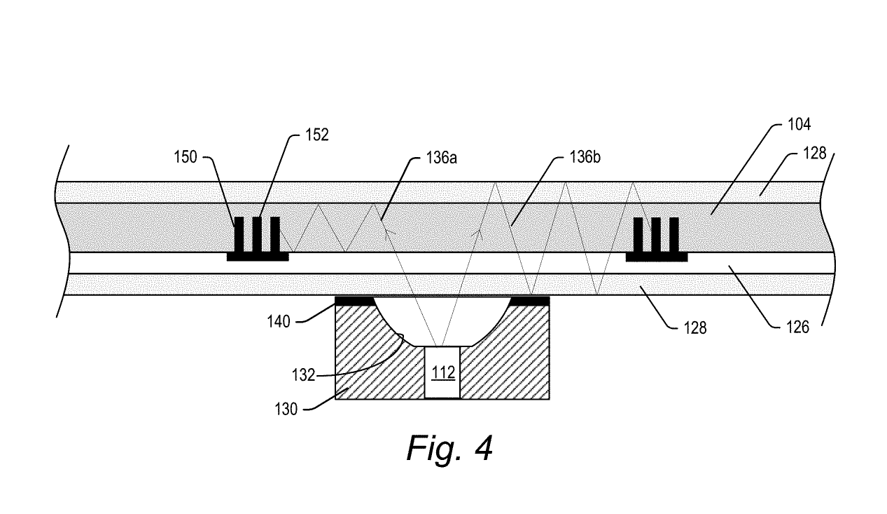

In addition to the shrouds 130 and gaskets 140, the light blocking components of the present technology may further include a pattern of grooves and/or an opaque material, individually or collectively referred to herein as light disrupting features. These light disrupting features are omitted from FIGS. 2 and 3 for clarity, but are shown in FIGS. 4-9. The shrouds and gaskets are effective at blocking light from reaching the sensors of the various cameras of HMD 2. However, to the extent light couples into the visor 104, this light is disrupted by the pattern of grooves and/or opaque material and prevented from reaching the optical sensors.

In general, the light disrupting features may be one or more features which scatter the light through mechanical features in or on the visor 104, out-couple the light through anti-guiding (using for example high index materials), and/or absorb the light with optically absorbing materials. In examples explained below, the light disrupting features may include grooves or abrasions in a surface of the visor and/or an optically opaque material within the grooves/abrasions or on a surface of the visor. The pattern of grooves and/or opaque material may be formed in one or both surfaces of the visor 104 completely encircling the light sources 112.

FIG. 4 shows a cross-sectional top view of a section of the visor 104 including light disrupting features in the form of a pattern of grooves 150 in a surface of the visor 104 around the light source 112. In the embodiment shown, the grooves 150 are formed around a shroud 130 and gasket 140 as described above. However, it is understood that the pattern of grooves 150 may be used with or without a shroud 130 and/or gasket 140 in further embodiments. It is further understood that the shape of the pattern of grooves 150 may vary in further embodiments used with or without a shroud 130.

The grooves 150 may be formed of a ring pattern of three separate grooves partially through the thickness of the visor 104. It is understood that there may be one, two or greater than three grooves 150 in a pattern of grooves in further embodiments. The grooves may be formed from a side of the visor 104 including the light source 112. However, as explained below, the grooves 150 may be formed into either surface of visor 104 or both surfaces of visor 104 in further embodiments.

In embodiments, the visor 104 may have a thickness of 1.5 mm, and the grooves 150 may be formed to a depth of 25 microns (μm) to 300 μm, and further for example 200 μm, through the thickness of the visor 104. It is understood that the depth of the grooves 150 may be less than 100 μm or greater than 300 μm in further embodiments. The grooves 150 may have a width, transverse to their depth, of 200 μm to 500 μm and further for example 400 μm. It is understood that the width of the grooves 150 may be less than 200μ greater than 500μ in further embodiments.

The pattern of grooves 150 may for example be defined during the injection molding process in which the visor 104 is formed. For example, the mold defining the shape and dimensions of visor 104 may include raised walls in the shape and dimensions of the grooves 150. In further embodiments, the grooves 150 may be machined into the visor 104 after it is fabricated, for example by a water jet cutting process. In a further embodiment, the grooves 150 may be formed using a laser.

The light disrupting features may further include an opaque material 152. For example, after the grooves 150 are formed, they may be filled with a material 152 opaque to the wavelengths of the one or more light sources 112 and having a higher index of refraction than the material of visor 104. The opaque material 152 may for example be black paint or epoxy which is painted on or printed into the grooves 150. As shown in FIG. 4, the opaque material 152 may also be applied to an outer surface of the visor 104, for example before the dye layer 126 is applied. Given the higher index of refraction of the material 152, waveguided light within the visor 104 striking the material 152 will be anti-guided (absorbed into) the opaque material 152, and prevented from reaching the optical sensors of the active and passive cameras described above.

Light may be waveguided into the visor due to the disparate indexes of refraction of the visor 104 and surrounding ambient environment. Alternatively or additionally, contamination such as finger prints and/or impurities in one or more surfaces of the visor may allow light to get trapped within the visor and transmitted through the visor by waveguiding. Light (136a) may be waveguided solely within the visor 104 alone. In further embodiments, light (136b) may be waveguided within the visor 104 and one or more of the coatings 126, 128. The pattern of grooves 150 and material 152 are provided to absorb waveguided light in both instances as shown in FIG. 4. The number of grooves 150 and the spacing between grooves 150 may be selected based on the wavelength of light from the one or more light sources 112 so as to capture all waveguided light. In embodiments, the spacing between grooves 150 may be 100 μm to 500 μm and may for example be 200 μm. It is understood that the spacing between grooves 150 may be lesson 100 μm or greater than 500 μm in further embodiments.

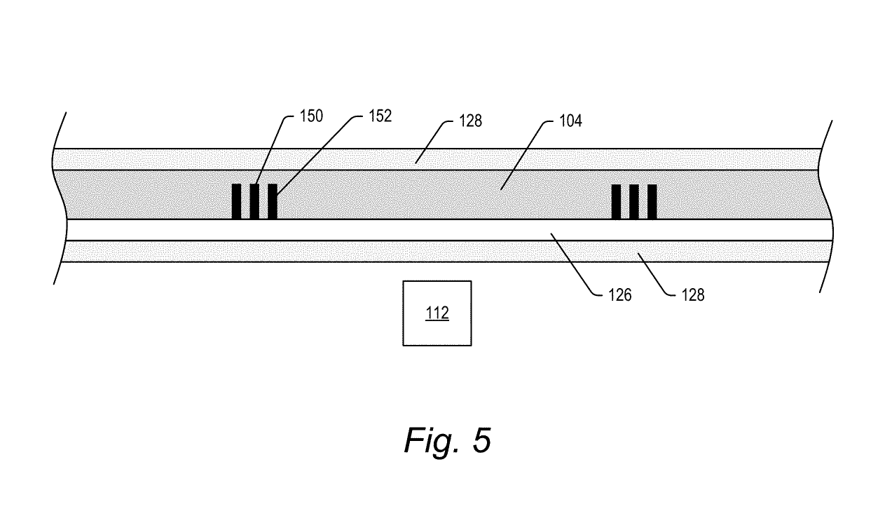

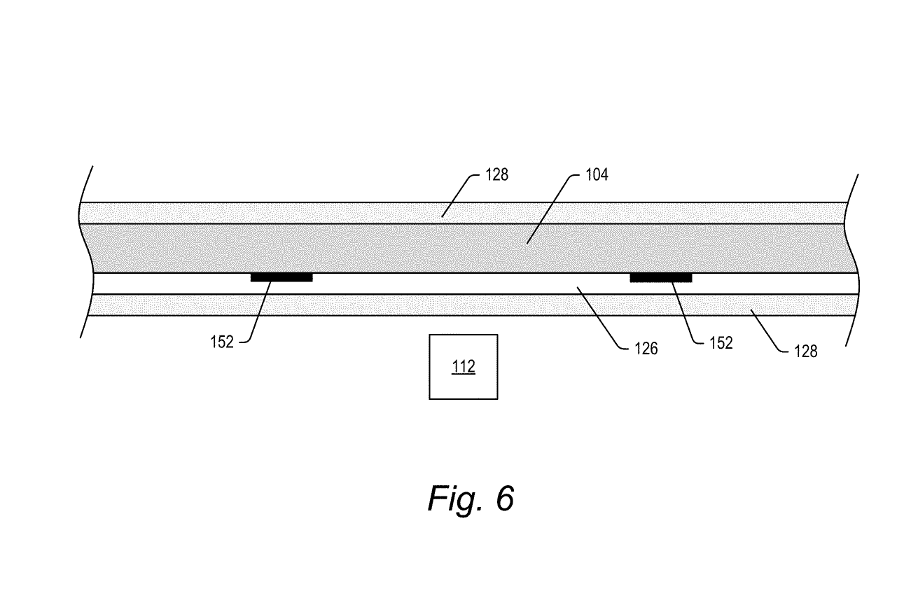

FIGS. 5-8 illustrate alternative light disrupting features comprised of patterns of grooves 150 and/or applications of material 152 to a surface of the visor 104. The pattern of grooves 150 in the embodiment of FIG. 5 is similar to the embodiment of FIG. 4, except that the material 152 is provided only within the grooves 150 and not on a surface of the visor 104. The pattern of grooves 150 in the embodiment of FIG. 6 is similar to the embodiment of FIG. 4, except that the grooves 150 are omitted and the material 152 is provided in a ring pattern around the light source 112 only on a surface of the visor 104. The ring pattern of material 152 in this embodiment may be on the inside or outside surface of the visor 104 nearest the light source 112 and/or on the surface of the visor 104 farthest from the light source 112.

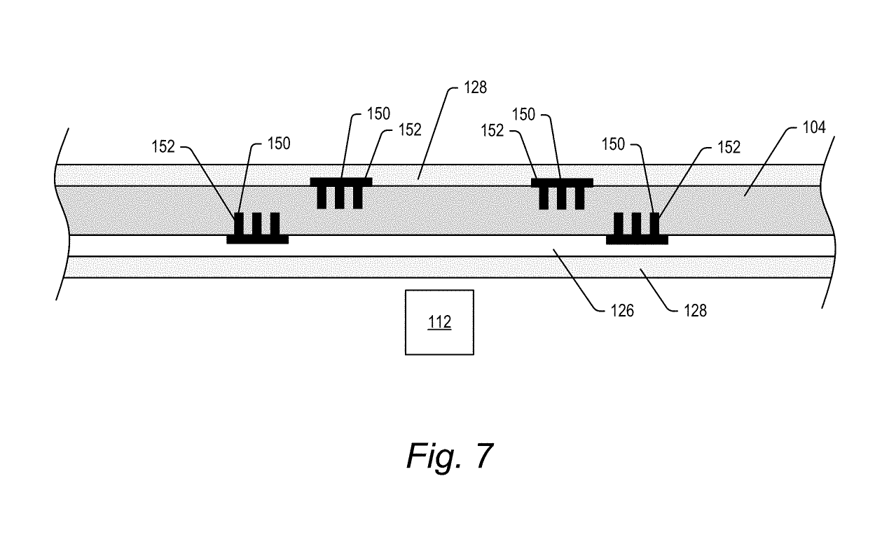

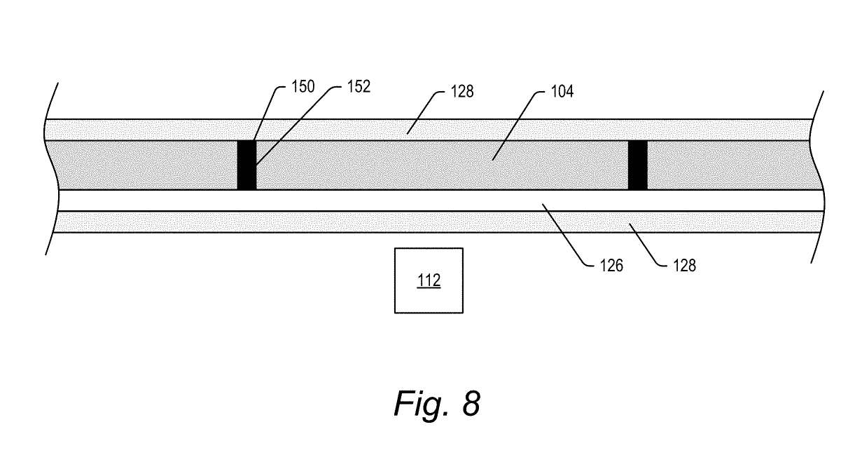

The pattern of grooves 150 in the embodiment of FIG. 7 is similar to the embodiment of FIG. 4, except that the grooves 150 and material 152 are provided in and on both surfaces of the visor 104. As noted above, the depth of the grooves 150 through the thickness of visor 104 may vary in embodiments. In the embodiment of FIG. 8, the grooves 150 are provided full thickness through the visor 104, i.e., the grooves 150 extend from one surface of the visor 104 to the opposed surface of the visor 104. The grooves 150 may then be filled with material 152 as described above.

In the embodiments of FIGS. 4-8 described above, the grooves 150 and material 152 are shown in and on the surfaces of visor 104. In further embodiments, the grooves 150 may additionally be provided through one or more of the layers 126, and the top and/or bottom layers 128. The material 152 may also additionally or alternatively be provided on one or more of the coated layers 126, 128.

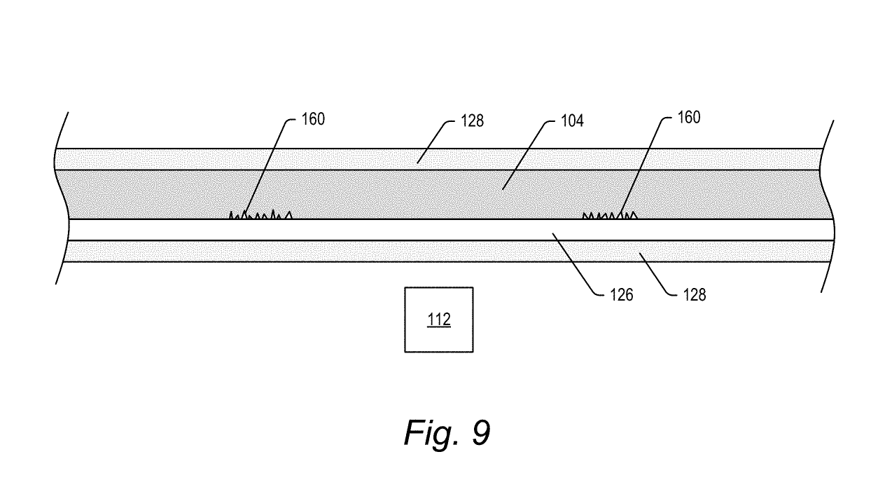

FIG. 9 illustrates a further embodiment for preventing waveguided light within the visor 104 from leaving the area around the light source 112. In the embodiment of FIG. 9, instead of grooves 150 or material 152, one or both surfaces of the visor 104 may be abraded or roughened to create light disrupting features in the form of a ring pattern of abrasions 160 around the light source 112. The ring pattern of abrasions 160 disrupt the internal reflection of waveguided light within the visor 104 and prevents or reduces the amount of waveguided light that may leave the light sources 112. The roughened pattern of abrasions 160 may be used alone or with any of the embodiments described above. Additionally, the roughened pattern of abrasions 160 may alternatively or additionally be provided on one or more of the coated layers 126, 128.

While some examples of light disrupting features such as grooves, abrasions and optically opaque materials have been described, it is understood that other light disrupting features may be provided which prevent light, waveguided within the visor, from leaving the one or more optical sensors of the active cameras. Other patterned structures may be formed on or in a surface of visor 104, other mechanical features may be molded or stamped into or on the visor 104, and other dielectric or other materials may be used for anti-guiding the waveguided light to prevent it from leaving the light source(s) 112.

Embodiments described above may be effective at providing at least 20 decibels of isolation with regard to the amount light from the one or more light sources 112 that is reflected or waveguided directly into the optical sensors of the active and passive cameras.

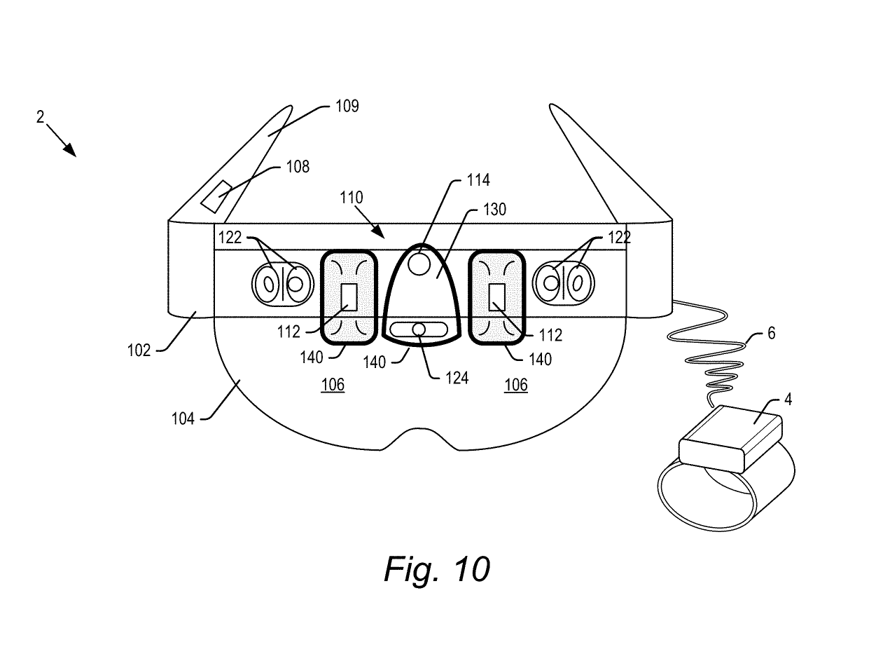

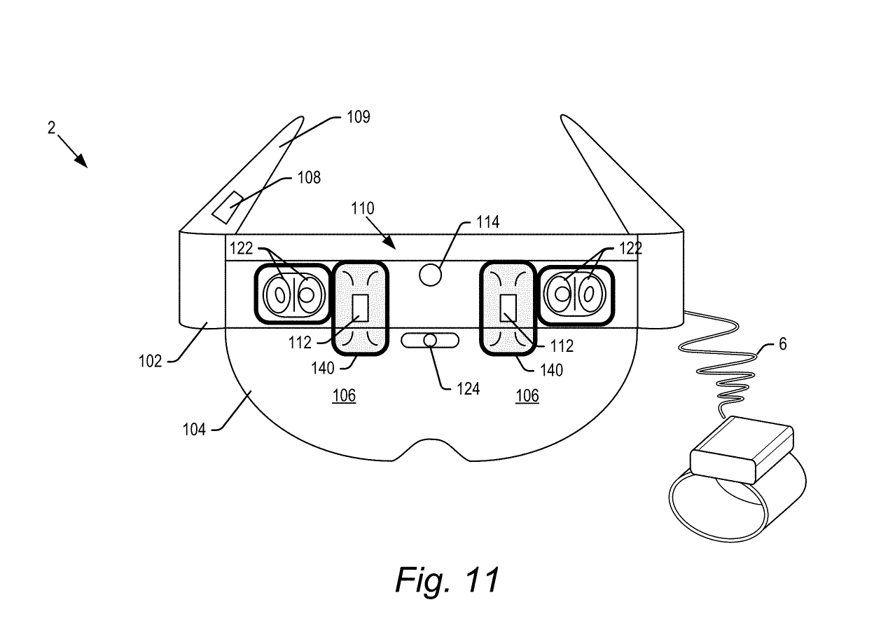

In addition to or instead of the above-described light blocking components around the light sources 112, one or more of the light blocking components (the shroud 130, gasket 140, grooves 150 and/or opaque material 152) may be applied around one or more of the optical sensors of the active and/or passive cameras. FIG. 10 illustrates an example where a shroud 130 and gasket 140 are also placed around the optical sensor 114 of the depth sensor 110 and around the video camera 124. A pattern of grooves 150 and/or opaque material 152 may also be provided around one or both of the optical sensor 114 of the depth sensor 110 and around the video camera 124. FIG. 11 illustrates an example where a shroud 130 and gasket 140 are placed around the head tracking cameras 122. A pattern of grooves 150 and/or opaque material 152 may also be provided around the head tracking cameras 122. One or more of the light blocking components may additionally or alternatively be applied around the optical sensors 120 of the eye tracking cameras 116.

In summary, in one example, the present technology relates to a system for reducing an amount of light transmitted from a light source of an imaging device to an optical sensor of the imaging device by a shield, the optical sensor being adjacent to the shield, the system comprising: light blocking components, the light blocking components comprising one or more of: a shroud formed around the light source and extending from the light source toward the shield, the shroud being opaque to wavelengths emitted by the light source, a gasket formed around an edge of the shroud and connecting the shroud to the shield, the gasket absorbing wavelengths of light emitted by the light source, and light disrupting features formed in or on a surface of the shield, the light disrupting feature blocking light waveguided within the shield.

In another example, the present technology relates to a system for reducing an amount of light transmitted from a light source of an imaging device to an optical sensor of the imaging device by a visor, the light source and optical sensor being adjacent to the visor, the system comprising: a shroud formed around the light source and extending from the light source toward the shield, the shroud being opaque to wavelengths emitted by the light source; a gasket formed around an edge of the shroud and connecting the shroud to the shield, the gasket absorbing wavelengths of light emitted by the light source; and light disrupting features formed in or on a surface of the visor for preventing light from waveguiding within the visor.

In a further example, the present technology relates to a method of forming an imaging device for a head mounted display device, the head mounted display device comprising a visor, and the display device comprising a light source and optical sensor positioned behind the visor when worn by a user, the method comprising: (a) forming a shroud around the light source, extending from the light source toward the visor; and (b) forming light disrupting features on or in a surface of the visor at least partially encircling an area of the visor adjacent to the light source.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for reducing an amount of light transmitted from a light source of an imaging device to an optical sensor of the imaging device by a shield, the optical sensor being adjacent to the shield, the system comprising:
light blocking components, the light blocking components comprising one or more of:
a shroud formed around the light source and extending from the light source toward the shield, the shroud being opaque to wavelengths emitted by the light source,
a gasket formed around an edge of the shroud and connecting the shroud to the shield, the gasket absorbing wavelengths of light emitted by the light source, and
light disrupting features formed in or on a surface of the shield, the light disrupting feature blocking light waveguided within the shield.

2. The system of claim 1, wherein the light disrupting features comprise a pattern of one or more grooves in a surface of the shield.

3. The system of claim 2, wherein the surface of the shield in which the grooves are formed is a surface of the shield in which the light source is adjacent.

4. The system of claim 2, wherein the grooves are formed at least partially through a thickness of the shield.

5. The system of claim 2, wherein the light disrupting features comprise material, opaque to wavelengths emitted by the light source.

6. The system of claim 5, wherein the material has a higher index of refraction than the shield.

7. The system of claim 5, wherein the material is black, optically opaque paint.

8. The system of claim 5, wherein the material is applied within the grooves.

9. The system of claim 5, wherein the material is applied to a surface of the shield.

10. The system of claim 1, wherein the light blocking components encircle the light source.

11. A system for reducing an amount of light transmitted from a light source of an imaging device to an optical sensor of the imaging device by a visor, the light source and optical sensor being adjacent to the visor, the system comprising:
a shroud formed around the light source and extending from the light source toward the shield, the shroud being opaque to wavelengths emitted by the light source;
a gasket formed around an edge of the shroud and connecting the shroud to the shield, the gasket absorbing wavelengths of light emitted by the light source; and
light disrupting features formed in or on a surface of the visor for preventing light from waveguiding within the visor.

12. The system of claim 11, wherein the light disrupting features comprise a pattern of one or more grooves formed in a first area of the visor into a surface of the visor.

13. The system of claim 11, wherein the light disrupting features comprise abrasions formed in a first area of the visor into a surface of the visor.

14. The system of claim 11, wherein the light disrupting features comprise a material, opaque to wavelengths emitted by the light source.

15. The system of claim 11, wherein the light disrupting features comprise:
a pattern of one or more grooves formed in a first area of the visor into a surface of the visor, and
a material at least partially filling the pattern of one or more grooves, the material being opaque to wavelengths emitted by the light source.

16. The system of claim 12, wherein the shroud, gasket and light disrupting features encircle the light source.

17. The system of claim 12, wherein the shroud, gasket and light disrupting features encircle the optical sensor.

18. A method of forming an imaging device for a head mounted display device, the head mounted display device comprising a visor, and the display device comprising a light source and optical sensor positioned behind the visor when worn by a user, the method comprising:
(a) forming a shroud around the light source, extending from the light source toward the visor; and
(b) forming light disrupting features on or in a surface of the visor at least partially encircling an area of the visor adjacent to the light source.

19. The method of claim 17, said step (b) of forming light disrupting features comprising the step of forming a pattern of grooves into a surface of the visor and applying a material, opaque to wavelengths emitted by the light source, to the pattern of grooves, the pattern of grooves and opaque material blocking light from the light source from entering the optical sensor via waveguiding through the visor.

20. The method of claim 17, further comprising the step of affixing the shroud to the visor using a gasket opaque to wavelengths emitted by the light source, the shroud and gasket preventing light from the light source from being transmitted to the optical sensor by reflection off of the visor.
